(19) United States
(12) Patent Application Publication
(10) Pub. No.: US 2026/0149178 A1
(43) Pub. Date: May 28, 2026

(54) CIRCULARLY POLARIZED ANTENNA UNIT, PHASED ARRAY ANTENNA, AND TERMINAL DEVICE

(71) Applicant: China Satellite Network Application Co., Ltd., Beijing (CN)

(72) Inventors: Xiaojie CHEN, Beijing (CN); Chuanfeng NIU, Beijing (CN); Run HE, Beijing (CN); Jianing LI, Beijing (CN); Fan ZHANG, Beijing (CN); Xinyuan ZHANG, Beijing (CN)

(73) Assignee: China Satellite Network Application Co., Ltd., Beijing (CN)

(21) Appl. No.: 19/425,976

(22) Filed: Dec. 18, 2025

Related U.S. Application Data
(63) Continuation of application No. PCT/CN2024/138158, filed on Dec. 10, 2024.

(30) Foreign Application Priority Data
Nov. 25, 2024 (CN) 202411700800.4

(51) Int. Cl. H01Q 9/04; H01Q 21/00; H01Q 21/06

(52) U.S. Cl. CPC H01Q 9/0428; H01Q 21/0006; H01Q 21/061

(57) ABSTRACT

A circularly polarized antenna unit, a phased array antenna, and a terminal device. The circularly polarized antenna unit includes first and second dielectric layers, a ground plate, a radiating patch, and a first feed line. The ground plate is located between the first dielectric layer and the second dielectric layer, and a surface of the ground plate away from the second dielectric layer has a slot of an annular shape with a notch. The radiating patch is located on a side of the first dielectric layer away from the ground plate, and the first feed line is located on a side of the second dielectric layer away from the ground plate. The first feed line includes a first feed port configured to allow electromagnetic waves to enter the slot. The slot is configured to couple the electromagnetic waves to the radiating patch to generate circularly polarized electromagnetic waves.

### CROSS-REFERENCE TO RELATED APPLICATION

This application is a continuation of International Application of PCT application serial no. PCT/CN2024/138158 filed on Dec. 10, 2024, which claims the priority benefit of China application serial no. 202411700800.4 filed on Nov. 25, 2024. The entirety of each of the above-mentioned patent applications is hereby incorporated by reference herein and made a part of this specification.

### BACKGROUND

### Technical Field

This application relates to the field of communication technology, more particularly to a circularly polarized antenna unit, a phased array antenna, and a terminal device.

### Description of Related Art

Phased array antennas have the advantages of beam agility, low profile, and easy conformal, and are widely used in on-board and ground terminals of broadband satellite communication systems. To reduce the impact of signal attenuation and multipath effects in the atmosphere and improve the transmission quality and stability of signals, broadband satellite communication systems usually use circularly polarized phased array antennas for communication, and require good axial ratio performance in a wide scanning range.

Currently, phased array antennas usually use antenna units including double-layer patches (a radiating patch and a parasitic patch) to achieve broadband performance, and use dual-port feeding with dual-slot coupling combined with a 90° hybrid coupler to achieve wide-angle circular polarization performance. This antenna has a simple structure and is convenient to process, and has been widely used. However, the cost of this antenna is relatively high, and the radiation efficiency still needs to be improved.

### SUMMARY

To alleviate, reduce, or eliminate the above-mentioned technical problems, the present application provides a circularly polarized antenna unit, a phased array antenna, and a terminal device.

In accordance with a first aspect, the present application provides a circularly polarized antenna unit, comprising: a first dielectric layer; a second dielectric layer arranged opposite to the first dielectric layer; a ground plate located between the first dielectric layer and the second dielectric layer, a surface of the ground plate away from the second dielectric layer being provided with a slot of an annular shape with a notch; a radiating patch located on a side of the first dielectric layer away from the ground plate; and a first feed line located on a side of the second dielectric layer away from the ground plate. The first feed line comprises a first feed port configured to allow electromagnetic waves to enter the slot. The slot is configured to couple the electromagnetic waves to the radiating patch to generate circularly polarized electromagnetic waves.

In accordance with a second aspect, the present application provides a phased array antenna, comprising the circularly polarized antenna unit as described in the first aspect.

In accordance with a third aspect, the present application provides a terminal device, comprising the phased array antenna as described in the second aspect.

It should be understood that the Summary is not intended to identify key or essential features of the embodiments of the present application, nor is it intended to limit the scope of the present application. Other features of the present application will become easy to understand through the following description.

### BRIEF DESCRIPTION OF THE DRAWINGS

The features and performance of the present application are further described by the following embodiments and their accompanying drawings.

FIG. 1 is a structural schematic diagram of a circularly polarized antenna unit provided in an embodiment of the present application;

FIG. 2 is a schematic diagram of the shape of a slot provided in an embodiment of the present application;

FIGS. 3A-3C are schematic diagrams of the shape of a slot provided in another embodiment of the present application;

FIGS. 4A-4B are schematic diagrams of the shape of a slot provided in another embodiment of the present application;

FIG. 5 is a schematic diagram of a relative position between a feed line and a slot provided in an embodiment of the present application;

FIGS. 6A-6B are schematic diagrams of feed points of a circularly polarized antenna unit provided in an embodiment of the present application;

FIG. 7 is a schematic diagram of a relative position between a feed line and a slot provided in another embodiment of the present application;

FIG. 8 is a schematic diagram of a simulation curve of a reflection coefficient of a circularly polarized antenna unit changing with frequency provided in an embodiment of the present application;

FIG. 9 is a schematic diagram of a simulation curve of an axial ratio in a direction perpendicular to an antenna aperture plane of a circularly polarized antenna unit changing with frequency provided in an embodiment of the present application;

FIG. 10 is a schematic diagram of a simulation curve of an axial ratio in a direction perpendicular to an antenna aperture plane of a circularly polarized antenna unit changing with elevation angle provided in an embodiment of the present application.

### DESCRIPTION OF THE EMBODIMENTS

The principles of the present application will now be described with reference to some embodiments. It should be understood that the description of these embodiments is merely for illustrative purposes, and helps those skilled in the art understand and implement the present application, without imposing any limitation on the scope of the present application. The disclosure described herein may be implemented in ways other than those described below.

In the following description, unless otherwise defined, all technical and scientific terms used herein have the same meaning as commonly understood by those of ordinary skill in the art to which the present application belongs.

References in the present application to “one embodiment”, “an embodiment”, “an exemplary embodiment”, etc., indicate that the described embodiment may include specific features, structures, or characteristics, but not every embodiment must include the specific features, structures, or characteristics. Moreover, such phrases are not necessarily referring to the same embodiment. In addition, when a specific feature, structure, or characteristic is described in conjunction with an exemplary embodiment, it is known to those skilled in the art that such feature, structure, or characteristic may be combined with other embodiments regardless of whether explicitly described.

The terms used in the present application are only for describing specific embodiments and are not intended to limit exemplary embodiments. The singular forms “a”, “an”, and “the” used in the present application also include plural forms unless the context clearly indicates otherwise. As used in the present application, “a set of elements” or “a collection of elements” is intended to include one or more elements. It should also be understood that the terms “comprise”, “comprising”, “has”, “having”, “comprises”, and/or “including”, when used in the present application, specify the presence of the stated features, elements, and/or components, etc., but do not exclude the presence or addition of one or more other features, elements, components, and/or combinations thereof.

As used in the present application, the term “communication system” refers to a network system following any appropriate communication standard, such as Long Term Evolution (LTE), LTE-Advanced (LTE-A), Wideband Code Division Multiple Access (WCDMA), High-Speed Packet Access (HSPA), Narrowband Internet of Things (NB-IoT), New Radio (NR), Non-Terrestrial Network (NTN), etc. In addition, communication between terminal device and network device in the communication system may be performed according to any appropriate generation of communication protocols, including but not limited to the first generation (1G), second generation (2G), 2.5G, 2.75G, third generation (3G), fourth generation (4G), 4.5G, fifth generation (5G), future sixth generation (6G) communication protocols, and/or any other currently known or future-developed protocols. Embodiments of the present application may be applied in satellite node communication systems. Considering the rapid development in communication, there will certainly be future types of communication technologies and systems, and the present application may be implemented with these technologies and systems. The scope of the present application should not be considered limited to the aforementioned systems.

The term “terminal device” refers to any terminal device capable of wireless communication. By way of example and not limitation, a terminal device may also be referred to as a communication device, User Equipment (UE), Subscriber Station (SS), Portable Subscriber Station, Mobile Station (MS), or Access Terminal (AT). The terminal device may include, but is not limited to, a mobile phone, a cellular phone, a smartphone, a Voice over IP (VoIP) phone, a Wireless Local Loop (WLL) phone, a tablet computer, a wearable terminal device, a Personal Digital Assistant (PDA), a portable computer, a desktop computer, an image capture terminal device such as a digital camera, a game terminal device, a music storage and playback device, an in-vehicle wireless terminal device, a wireless endpoint, a mobile station, a Laptop Embedded Equipment (LEE), a Laptop Mounted Equipment (LME), a USB dongle, a smart device, a Customer Premises Equipment (CPE), an Internet of Things (IoT) device, a watch or other wearable devices, a Head-Mounted Display (HMD), a vehicle, an unmanned aerial vehicle (UAV), medical devices and applications (e.g., tele-surgery), industrial devices and applications (e.g., robots and/or other wireless devices operating in the context of industrial and/or automated processing chains), consumer electronic devices, relay nodes, devices operating on commercial and/or industrial wireless networks, etc. The Mobile Terminal (MT) part of an IAB node may perform the function of a “terminal device” and thus may operate as a terminal device. In the following description, the terms “terminal device”, “terminal”, “user equipment”, and “UE” may be used interchangeably.

Currently, common frequency bands for satellite services include the C-band (4-8 GHz), Ku-band (12-18 GHz), and Ka-band (24-40 GHz). Taking the Ka-band as an example, a Ka-band broadband satellite communication system has an operating bandwidth exceeding 12% and achieves a scanning range of −70°˜+70° in the elevation direction. Therefore, the antenna unit is required to have broadband and wide-angle circular polarization operating capabilities.

In a satellite communication system, the phased array antenna of a terminal device usually uses an antenna unit including double-layer patches (a radiating patch and a parasitic patch) to achieve broadband performance, and its processing requires at least three dielectric plates, which increases the antenna processing cost. Meanwhile, dual-port feeding with dual-slot coupling combined with a 90° hybrid coupler is usually used to achieve wide-angle circular polarization performance. The introduction of the 90° hybrid coupler increases antenna loss. For example, in the Ka-band, the 90° hybrid coupler will bring a loss of 0.5˜1 dB.

Single-port feeding may be used to achieve circular polarization, and specific implementation schemes include the following two types:
1) Circular polarization is achieved by adopting methods such as corner cutting and slot loading to change the surface current distribution of the radiating patch, thereby exciting two orthogonal modal currents with equal amplitude and a 90° phase difference.
2) Circular polarization is achieved by adopting slot coupling feeding, modifying the shape of the coupling slot from a straight shape or I-shape to an L-shape or cross shape. Two orthogonal modal currents are excited on the radiating patch through slot coupling, which can be equivalent to providing two feed points with equal amplitude and a 90° phase difference for the radiating patch.

In the first scheme, both the operating bandwidth and the axial ratio bandwidth of the antenna are relatively narrow, which cannot meet the usage requirements of the Ka-band broadband satellite communication system. In the second scheme, although both the operating bandwidth and the axial ratio bandwidth of the antenna are significantly improved compared with the first scheme, the axial ratio bandwidth is still less than 10%, and the axial ratio beamwidth cannot cover the range of −70°˜+70° either.

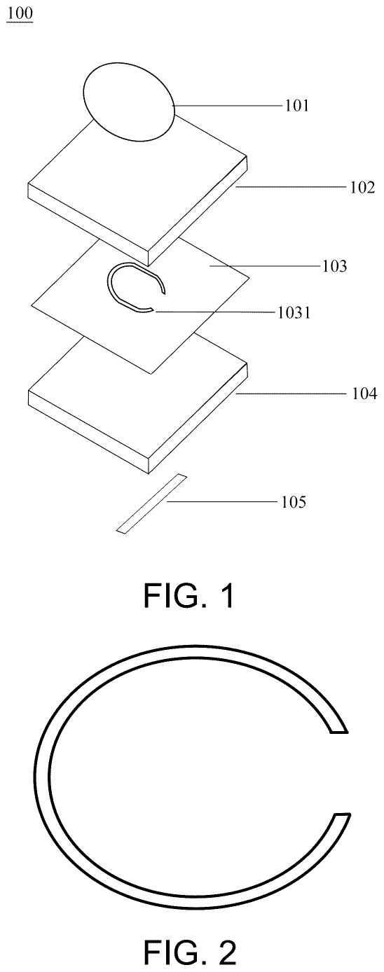

FIG. 1 is a schematic structural diagram of a circularly polarized antenna unit provided in an embodiment of the present application. As shown in FIG. 1, the circularly polarized antenna unit 100 comprises a radiating patch 101, a first dielectric layer 102, a ground plate 103, a second dielectric layer 104, and a first feed line 105. The radiating patch 101 is located on a side of the first dielectric layer 102 away from the ground plate 103. The shape of the radiating patch 101 may be elliptical, circular, polygonal, or other shapes.

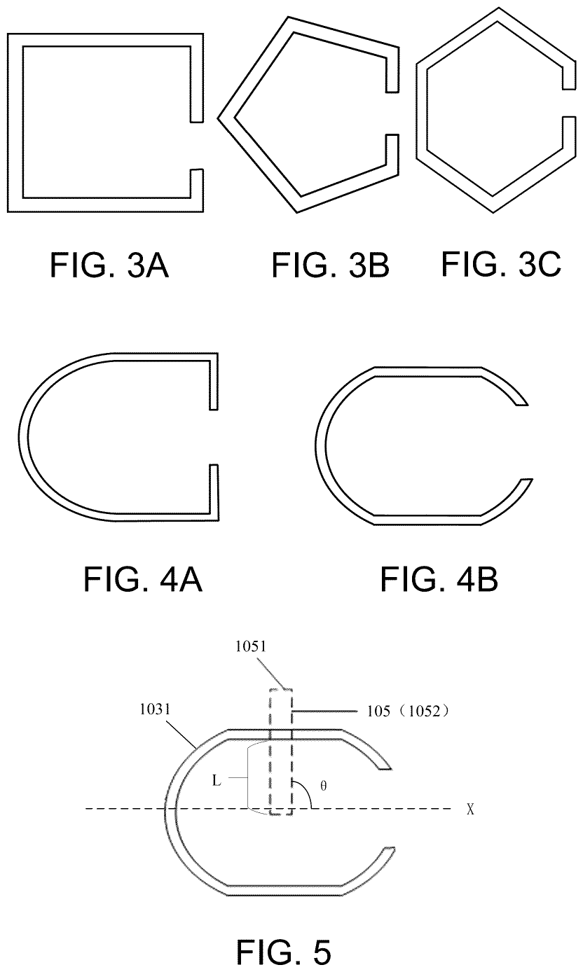

The ground plate 103 is located between the first dielectric layer 102 and the second dielectric layer 104. A surface of the ground plate 103 away from the second dielectric layer 104 is provided with a slot 1031 of an annular shape with a notch. The shape of the slot 1031 is an annular shape with a notch. It should be understood that the term “annular shape” as used herein does not necessarily refer to a perfect circle. In one example, the shape of the slot 1031 is an elliptical annular shape with a notch or a circular annular shape with a notch, as shown in FIG. 2. In another example, the shape of the slot 1031 is a polygonal annular shape with a notch such as a quadrilateral annular shape with a notch, pentagonal annular shape with a notch, hexagonal annular shape with a notch, etc., as shown in FIGS. 3A-3C. In another example, the shape of the slot 1031 is a mixed shape with a notch of an elliptical annular shape or a circular annular shape and a polygonal annular shape, as shown in FIGS. 4A-4B. The width of the slot 1031 at different positions may be the same or different. In one embodiment, the slot 1031 may be formed by etching a thin metal layer on the ground plate 103, and the depth of the slot 1031 may be the thickness of the thin metal layer on the ground plate 103.

In some embodiments, the ratio of the length of a straight line connecting the two ends of the notch to the length of the slot is less than or equal to 0.25. For example, the ratio may be 0.25, 0.2, 0.15, or 0.1, etc. In one example, the length of the slot 1031 is J, and the length of the straight line connecting the two ends of the notch is less than or equal to 0.25 J. For example, the length of the straight line connecting the two ends of the notch may be 0.25 J, 0.2 J, 0.15 J, or 0.1 J, etc.

In some embodiments, the length of the slot 1031 is approximately 1.5 times the guided wavelength of the slot at the center frequency of the operating band of the circularly polarized antenna unit 100, i.e., 1.5×λ_{g}. Wherein, λ_{g}=λ₀/\sqrt{ε_{eff}}, which is the guided wavelength of the slot at the center frequency of the operating band, λ₀ is the free-space wavelength at the center frequency of the operating band of the circularly polarized antenna unit, and ε_{eff} is the effective dielectric constant of the slot. It should be understood that, as used herein, the term “approximately” refers to an equal relationship considering the range of manufacturing process errors.

In some embodiments, a center point of an orthographic projection of the radiating patch 101 on the ground plate 103 coincides with a center point of the slot 1031. Alternatively or additionally, the orthographic projection of the radiating patch 101 on the ground plate 103 covers at least the inner edge of the slot 1031, that is, the inner edge of the slot 1031 is located within the orthographic projection of the radiating patch 101 on the ground plate 103, or both the outer edge and the inner edge of the slot 1031 are located within the orthographic projection of the radiating patch 101 on the ground plate 103. As used herein, the term “center point” may refer to the geometric center.

The first feed line 105 is located on a side of the second dielectric layer 104 away from the ground plate 103. With reference to FIG. 5, the first feed line 105 comprises a first feed port 1051. The first feed port 1051 is configured to allow electromagnetic waves to enter the slot 1031, wherein the slot 1031 is configured to couple the electromagnetic waves to the radiating patch 101 to generate circularly polarized electromagnetic waves.

In the application process, electromagnetic waves enter the slot 1031 from the first feed port 1051, forming a traveling-standing wave distribution in the slot 1031, and are coupled to the radiating patch 101 through the slot 1031. The electromagnetic waves distributed along the slot 1031 have a phase difference, which can provide multiple feed points with different phases for the radiating patch 101, thereby generating circularly polarized electromagnetic waves and radiating them into free space. In some embodiments, four feed points with phases of 0°, 90°, 180°, and 270° respectively may be provided for the radiating patch 101. Compared with the coupling slot of an L-shaped or cross-shaped slot-coupled antenna that provides two feed points with phases of 0° and 90° respectively for the radiating patch, the antenna in the embodiment of the present application has a wider axial ratio bandwidth and axial ratio beamwidth. Meanwhile, the embodiment of the present application can avoid the loss caused by the 90° hybrid coupler and improve the antenna radiation efficiency.

By way of example and not limitation, the first feed line 105 may be a microstrip feed line or a stripline feed line. In some embodiments, with reference to FIG. 7, the first feed line 105 comprises a first straight segment 1052. For example, the first feed line 105 is in a shape with a straight segment such as a straight line or an L-shape, and the first feed port 1051 is located at one end of the first straight segment 1052. A first orthographic projection of the first straight segment 1052 on the ground plate 103 intersects the slot 1031 at a first intersection point, one end of the first orthographic projection is located outside the annular shape, and another end of the first orthographic projection is located inside the annular shape. When an orthographic projection of the first feed port 1051 on the ground plate 103 is located outside the annular shape, as shown in FIG. 5, a portion of an orthographic projection of the first feed line 105 on the ground plate 103 located inside the annular shape has a length L of approximately one quarter of a guided wavelength of the first feed line 105 at a center frequency of an operating band of the circularly polarized antenna unit. When an orthographic projection of the first feed port 1051 on the ground plate 103 is located inside the annular shape, a portion of the orthographic projection of the first feed line 105 on the ground plate 103 located outside the annular shape has a length of approximately one quarter of a guided wavelength of the first feed line 105 at the center frequency of an operating band of the circularly polarized antenna unit.

The first orthographic projection of the first straight segment 1052 on the ground plate 103 intersects the slot 1031 perpendicularly at the first intersection point. For example, the slot 1031 is a circular annular shape with a notch, and the perpendicular intersection of the first orthographic projection and the slot 1031 at the first intersection point means that the first orthographic projection is perpendicular to the outer tangent of the annular shape at the first intersection point. For another example, the slot 1031 is a polygonal annular shape with a notch, and the perpendicular intersection of the first orthographic projection and the slot 1031 at the first intersection point means that the first orthographic projection is perpendicular to the surface where the first intersection point is located.

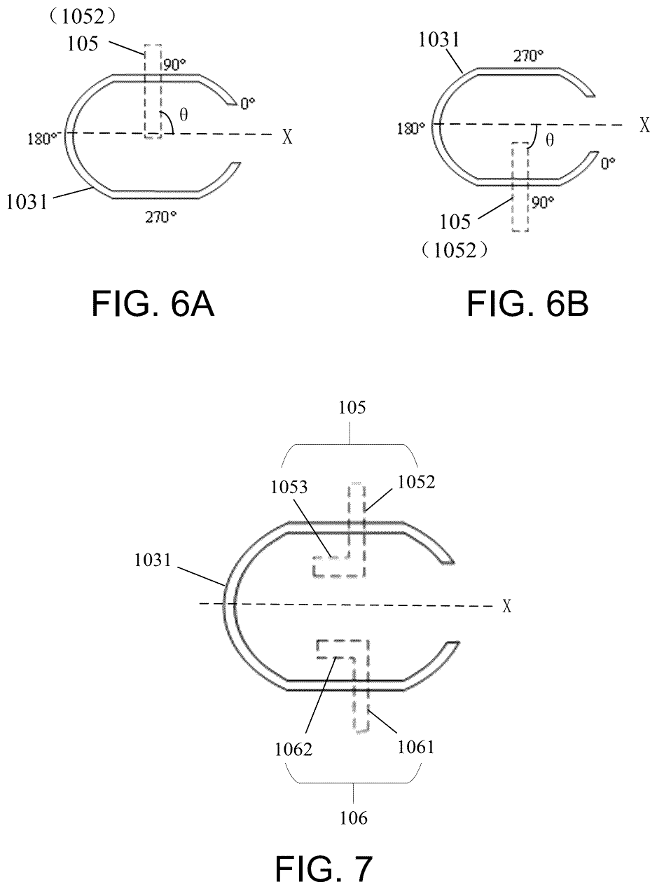

The embodiment of the present application defines a straight line connecting the center point of the annular shape and the center point of the notch as the center line X. The included angle θ between the first orthographic projection of the first straight segment 1052 on the ground plate 103 and the center line X toward the notch of the slot 1031 is 90°-135°, such as 90°, 100°, 110°, 120°, 130°, 135°, etc. Please refer to FIGS. 5 and 6A-6B, the included angle θ between the first orthographic projection of the first straight segment 1052 on the ground plate 103 and the center line X toward the notch of the slot 1031 is 90°.

The relative position between the first feed line 105 and the slot 1031 determines the rotation direction of the circularly polarized wave radiated by the circularly polarized antenna unit. Please refer to FIGS. 6A-6B. In the embodiment shown in FIG. 6A, the phase of the electromagnetic wave distributed along the slot 1031 at the first intersection point is 90°, the phase at the notch close to the first intersection point is 0°, the phase at the intersection point of the slot 1031 and the center line X is 180°, and the phase at the position of the first intersection point symmetrical about the center line X is 270°, so that the circularly polarized antenna unit radiates a right-hand circularly polarized wave. In the embodiment shown in FIG. 6B, the circularly polarized antenna unit radiates a left-hand circularly polarized wave.

In some embodiments, the circularly polarized antenna unit 100 may include multiple feed lines, and multiple circularly polarized waves are implemented through multiple feed ports. With reference to FIG. 7, the circularly polarized antenna unit further comprises a second feed line 106 that does not intersect with the first feed line 105, and the second feed line 106 is also located on a side of the second dielectric layer 104 away from the ground plate 103. For example, the arrangement of the second feed line 106 may refer to the first feed line 105, which is not described in detail here.

In some embodiments, a second orthographic projection of the second straight segment 1061 of the second feed line 106 on the ground plate 103 intersects the slot 1031 at the second intersection point. The second intersection point and the first intersection point may be symmetrical about the center line X. For example, the first feed line 105 and the second feed line 106 are symmetrically arranged about the center line X, so that the circularly polarized antenna unit can radiate right-hand and left-hand circularly polarized waves to achieve dual circular polarization.

In some embodiments, the first feed line 105 comprises a first bent segment 1053 connected to one end of the first straight segment 1052 facing inward the annular shape, and wherein the second feed line 106 comprises a second bent segment 1062 connected to one end of the second straight segment 1061 facing inward the annular shape. The directions of the first bent segment 1053 and the second bent segment 1062 may be the same or different. In the embodiment of the present application, through the arrangement of the bent segments, the first feed line 105 and the second feed line 106 can be as close as possible without intersecting, thereby improving the isolation between the two feed ports.

In some embodiments, the first dielectric layer 102 and the second dielectric layer 104 may be dielectric plates, and the dielectric constant of the second dielectric layer 104 is greater than that of the first dielectric layer 102. In some embodiments, the first dielectric layer 102 may alternatively be air, and the radiating patch 101 is fixed on the side of the ground plate 103 away from the second dielectric layer 104 through an intermediate overhead structure. The embodiment of the present application can achieve broadband operation with a single-layer radiating patch, and only two dielectric plates are needed. Compared with the traditional way of achieving broadband operation with double-layer patches including radiating patch and parasitic patch, the use of one dielectric plate and parasitic patch can be reduced, thereby reducing the cost.

In an exemplary embodiment, the circularly polarized antenna unit comprises only one feed line, such as only the first feed line 105. In the circularly polarized antenna unit, the first feed line 105 is straight with a width of 0.358 mm; the radiating patch 101 is a circular patch with a radius of 1.55 mm; the slot 1031 on the ground plate 103 is a circular annular shape with a notch, the radius of the annular shape is 1.3 mm, the perimeter of the notch is 0.2 mm, and the width of the slot is 0.12 mm; the thickness of the first dielectric layer 102 is 1.016 mm, and the dielectric constant is 2.6; the thickness of the second dielectric layer 104 is 0.254 mm, and the dielectric constant is 6.15.

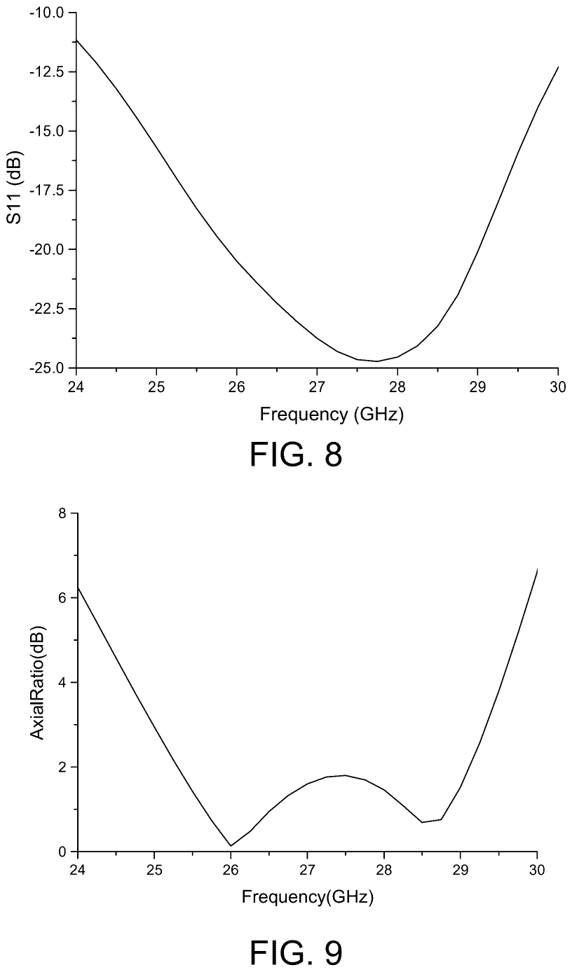

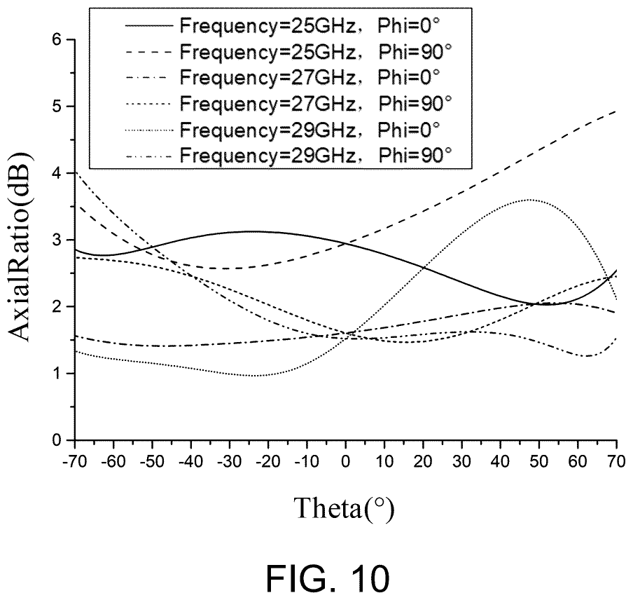

Based on the circularly polarized antenna unit in the above exemplary embodiment, assuming that the circularly polarized antenna unit operates in the Ka-band, the corresponding simulation results are given in FIGS. 8-10. FIGS. 8 and 9 respectively show simulation curves of the reflection coefficient (S11) and the axial ratio (AxialRatio) in the direction perpendicular to the antenna aperture plane of the circularly polarized antenna unit changing with frequency (Frequency). It can be seen from FIG. 8 that in the frequency range of 25-29 GHz, S11 is less than 15 dB. It can be seen from FIG. 9 that in the frequency range of 25-29 GHz, the antenna axial ratio is less than 3 dB, and the axial ratio bandwidth is about 14.8%. FIG. 10 shows a simulation curve of the axial ratio (AxialRatio) in the direction perpendicular to the antenna aperture plane of the circularly polarized antenna unit changing with the elevation angle (Theta). It can be seen from FIG. 10 that at three frequency points of 25 GHz, 27 GHz, and 29 GHz, when the azimuth angle (Phi) is 0° and 90° respectively, the antenna axial ratio is less than 5 dB within the elevation angle Theta range of ±70°. It can be seen that the operating bandwidth and axial ratio bandwidth of the circularly polarized antenna unit provided by the embodiment of the present application are wider than those of the existing circularly polarized antenna units, and the axial ratio beamwidth can cover the range of −70°˜+70°.

Although several specific implementation details are included in the above discussion, these details should not be construed as limiting the scope of the present application, but may be construed as descriptions of specific features to specific embodiments. Certain features described in the context of separate embodiments may also be implemented in combination in a single embodiment. Conversely, various features described in the context of a single embodiment may also be implemented in multiple embodiments individually or in any appropriate subcombination.

Although the present application has been described in language specific to structural features and/or method acts, it should be understood that the present application as defined in the appended claims is not necessarily limited to the specific features or acts described above. On the contrary, the specific features and acts described above are disclosed as exemplary forms of implementing the claims.

What is claimed is:

1. A circularly polarized antenna unit, comprising:
a first dielectric layer;
a second dielectric layer arranged opposite to the first dielectric layer;
a ground plate located between the first dielectric layer and the second dielectric layer, wherein a surface of the ground plate away from the second dielectric layer is provided with a slot of an annular shape with a notch;
a radiating patch located on a side of the first dielectric layer away from the ground plate; and
a first feed line located on a side of the second dielectric layer away from the ground plate, wherein the first feed line comprises a first feed port configured to allow electromagnetic waves to enter the slot,
wherein the slot is configured to couple the electromagnetic waves to the radiating patch to generate circularly polarized electromagnetic waves.

2. The circularly polarized antenna unit of claim 1, wherein the first feed line comprises a first straight segment, the first feed port being located at one end of the first straight segment; and
wherein a first orthographic projection of the first straight segment on the ground plate intersects the slot at a first intersection point, one end of the first orthographic projection being located outside the annular shape, and another end of the first orthographic projection being located inside the annular shape.

3. The circularly polarized antenna unit of claim 2, wherein an orthographic projection of the first feed port on the ground plate is located outside the annular shape, and a portion of an orthographic projection of the first feed line on the ground plate located inside the annular shape has a length of approximately one quarter of a guided wavelength of the first feed line at a center frequency of an operating band of the circularly polarized antenna unit.

4. The circularly polarized antenna unit of claim 2, wherein an orthographic projection of the first feed port on the ground plate is located inside the annular shape, and a portion of an orthographic projection of the first feed line on the ground plate located outside the annular shape has a length of approximately one quarter of a guided wavelength of the first feed line at a center frequency of an operating band of the circularly polarized antenna unit.

5. The circularly polarized antenna unit of claim 2, wherein the first orthographic projection intersects the slot perpendicularly at the first intersection point, and an included angle between the first orthographic projection and a center line toward the notch is 90°-135°, wherein the center line is a straight line connecting a center point of the annular shape and a center point of the notch.

6. The circularly polarized antenna unit of claim 1, wherein a ratio of a length of a straight line connecting two ends of the notch to a length of the slot is less than or equal to 0.25.

7. The circularly polarized antenna unit of claim 1, wherein a length of the slot is approximately 1.5 times a guided wavelength of the slot at a center frequency of an operating band of the circularly polarized antenna unit.

8. The circularly polarized antenna unit of claim 1, wherein an orthographic projection of the radiating patch on the ground plate covers an inner edge of the slot.

9. The circularly polarized antenna unit of claim 1, wherein a center point of an orthographic projection of the radiating patch on the ground plate coincides with a center point of the slot.

10. The circularly polarized antenna unit of claim 1, wherein a dielectric constant of the second dielectric layer is greater than a dielectric constant of the first dielectric layer.

11. The circularly polarized antenna unit of claim 1, wherein the first dielectric layer is air.

12. The circularly polarized antenna unit of claim 2, further comprising a second feed line located on a side of the second dielectric layer away from the ground plate, the second feed line being not intersecting with the first feed line;
wherein the second feed line comprises a second feed port configured to allow electromagnetic waves to enter the slot.

13. The circularly polarized antenna unit of claim 12, wherein the second feed line comprises a second straight segment, the second feed port being located at one end of the second straight segment; and
wherein a second orthographic projection of the second straight segment on the ground plate intersects the slot at a second intersection point, one end of the second orthographic projection being located outside the annular shape, and another end of the second orthographic projection being located inside the annular shape.

14. The circularly polarized antenna unit of claim 13, wherein an orthographic projection of the second feed port on the ground plate is located outside the annular shape, and a portion of an orthographic projection of the second feed line on the ground plate located inside the annular shape has a length of approximately one quarter of a guided wavelength of the second feed line at a center frequency of an operating band of the circularly polarized antenna unit.

15. The circularly polarized antenna unit of claim 13, wherein an orthographic projection of the second feed port on the ground plate is located inside the annular shape, and a portion of an orthographic projection of the second feed line on the ground plate located outside the annular shape has a length of approximately one quarter of a guided wavelength of the second feed line at a center frequency of an operating band of the circularly polarized antenna unit.

16. The circularly polarized antenna unit of claim 13, wherein the second orthographic projection intersects the slot perpendicularly at the second intersection point, and an included angle between the second orthographic projection and a center line toward the notch is 90°-135°, wherein the center line is a straight line connecting a center point of the annular shape and a center point of the notch.

17. The circularly polarized antenna unit of claim 13, wherein the first feed line and the second feed line are symmetrical about a center line, wherein the center line is a straight line connecting a center point of the annular shape and a center point of the notch.

18. The circularly polarized antenna unit of claim 17, wherein the first feed line further comprises a first bent segment connected to one end of the first straight segment facing inward the annular shape; and
wherein the second feed line further comprises a second bent segment connected to one end of the second straight segment facing inward the annular shape.

19. A phased array antenna, comprising the circularly polarized antenna unit of claim 1.

20. A terminal device, comprising the phased array antenna of claim 19.
